(19) United States
(12) Patent Application Publication
(10) Pub. No.: US 2005/0093991 A1
(43) Pub. Date: May 5, 2005

(54) Black level correction circuit and black level correction method for video camera using solid state image pickup device

(76) Inventors: Masahiro Yokohata, Osaka City (JP); Seiji Okada, Hirakata City (JP); Yukio Mori, Hirakata City (JP); Haruhiko Murata, Ibaraki City (JP)

Correspondence Address: MCDERMOTT WILL & EMERY LLP, 600 13th Street, N.W., Washington, DC, 20005-3096, US

(21) Appl. No.: 10/950,687

(22) Filed: Sep. 28, 2004

(30) Foreign Application Priority Data
Sep. 30, 2003 (JP) 2003-339029

(51) Int. Cl. H04N 5/228

(52) U.S. Cl. 348/222.1

(57) ABSTRACT

A black level correction circuit for a video camera using a solid state image pickup device includes: means comparing an average luminance on each horizontal line in an optical black region of a reference black image with an average luminance on the corresponding horizontal line in an optical black region of an input image to thereby obtain a gain on the horizontal line in order to equalize an optical black level of the reference black image with an optical black level of the input image; means multiplying each of pixel values on each horizontal line in an effective pixel region of the reference black image by the obtained gain on the corresponding horizontal line; and means subtracting each pixel value obtained by the multiplication from a pixel value of the corresponding pixel in the effective pixel region of the input image.

### BACKGROUND OF THE INVENTION

1. Field of the Invention

The present invention relates to a black level correction circuit and black level correction method for a video camera using a solid state image pickup device.

2. Prior Art

Black level correction has been performed in a video camera using a solid state image pickup device in a way such that since an output signal level (a black level) of the solid state image pickup device in a state not receiving incident light is altered by ambient temperature and an exposure time, the black level is corrected to a no-signal level (see JP-A No. 8-321970).

In a video camera using a solid state image pickup device, a case has been arisen where noise such as a stripe pattern in a longitudinal direction or the like occurs fixedly in a specific portion on a screen. Such noise is called a fixed pattern noise, which is fixedly observed without altering its position as far as the same solid state image pickup device is used.

In a conventional black level correction method, a black level can be corrected to a no-signal level, whereas a fixed pattern noise has been unable to be removed.

### SUMMARY OF THE INVENTION

It is an object of the present invention to provide a black level correction circuit and black level correction method, capable of not only correcting a black level to a no-signal level but also removing a fixed pattern noise, for a video camera using a solid state image pickup device.

A black level correction circuit for a video camera using a solid state image pickup device according to the present invention includes: first means generating and holding a reference black image based on an output of the solid state image pickup device in a state of no incident light; second means calculating an average luminance on each horizontal line in an optical black region of the reference black image; third means calculating an average luminance on each horizontal line in an optical black region of an input image; fourth means comparing the average luminance calculated by the second means with the average luminance calculated by the third means on each horizontal line to thereby obtain a gain on the corresponding horizontal line in order to equalize an optical black level of the reference black image with an optical black level of the input image; fifth means multiplying each of pixel values on each horizontal line in an effective pixel region of the reference black image by the obtained gain on the corresponding horizontal line to thereby correct a signal level in the effective pixel region of the reference black image so as to be equal to an optical black level of the input image; and sixth means subtracting a pixel value after the correction in the effective pixel region of the reference black image from a pixel value of the corresponding pixel in the effective pixel region of the input image.

A black level correction method for a video camera using a solid state image pickup device according to the present invention includes: a first step generating and holding a reference black image based on an output of the solid state image pickup device in a state of no incident light; a second step calculating an average luminance on each horizontal line in an optical black region of the reference black image; a third step calculating an average luminance on each horizontal line in an optical black region of an input image; a fourth step comparing the average luminance calculated by the second means with the average luminance calculated by the third means on each horizontal line to thereby obtain a gain on the corresponding horizontal line in order to equalize an optical black level of the reference black image with an optical black level of the input image; a fifth step multiplying each of pixel values on each horizontal line in an effective pixel region of the reference black image by an obtained gain on the corresponding horizontal line to thereby correct a signal level in the effective pixel region of the reference black image so as to be equal to an optical black level of the input image; and a sixth step subtracting a pixel value after the correction in the effective pixel region of the reference black image from a pixel value of the corresponding pixel in the effective pixel region of the input image.

### BRIEF DESCRIPTION OF THE DRAWINGS

FIG. 1 is a model representation for describing black level correction processing in a video camera;

FIG. 2 is a model view showing an optical black region 11 and an effective pixel region 12;

FIG. 3 is a block diagram showing an electric configuration of a video camera; and

FIG. 4 is a block diagram showing an electric configuration of a black level correction circuit.

### DETAILED DESCRIPTION OF THE PREFERRED EMBODIMENTS

Description will be given of embodiments of the present invention with reference to the accompanying drawings below.

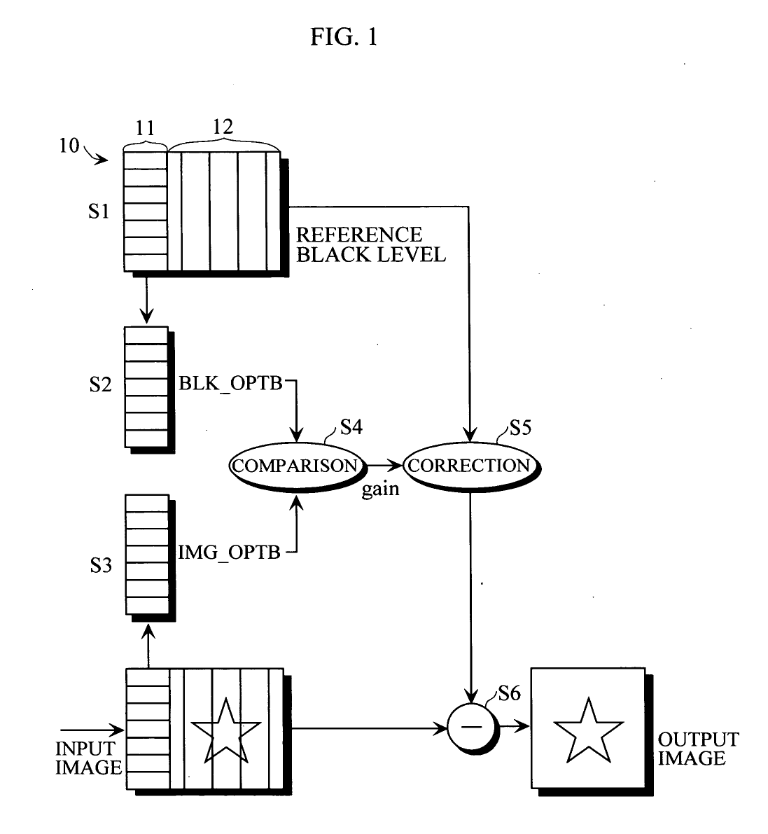

FIG. 1 is a representation for describing black level correction processing in a video camera.

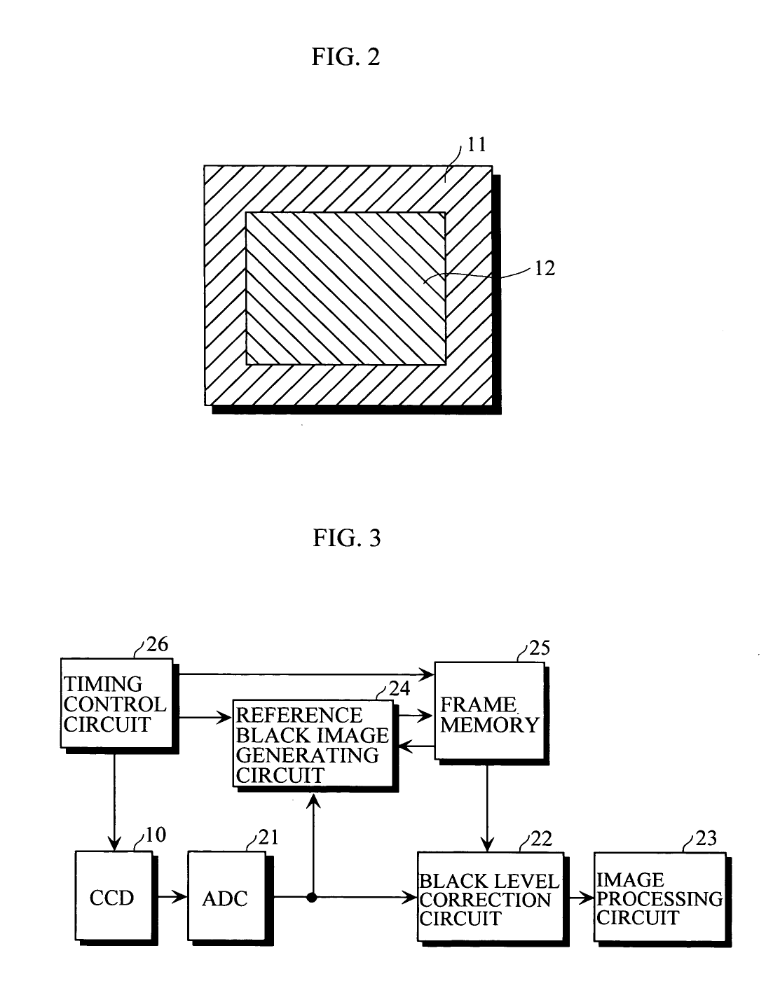

First of all, preprocessing is described. A reference black image is generated and held based on an output of a CCD (a solid state image pickup device) 10 in a state of no incident light (step 1). The CCD 10 includes: an optical black region 11, which is a light interception region; and an effective pixel region 12, which is non-light intercepting region. To be concrete, the optical black region 11 is, as shown in FIG. 2, placed around the effective pixel region 12. Longitudinal lines in the effective pixel region 12 indicates a fixed pattern noise. A reference black image is generated by averaging black images in plural frames.

The processing thus far (preprocessing) may be performed either prior to shipment of a video camera or each time a power supply of the video camera is turned on.

Description will be given of processing for performing black level correction on an input image below. The following processing is performed on each input image.

An average luminance BLK_OPTB on each horizontal line is calculated in the optical black region 11 of a reference black image (step S2). Note that in order to reduce a fluctuation in the calculated average luminance BLK_OPTB on each horizontal line, a IIR filter may be applied to the calculated average luminance BLK_OPTB on each horizontal line from above the screen to therebelow.

An average luminance IMG_OPTB on each horizontal line is calculated in the optical black region 11 of an input image (step S3).

Then, the average luminance BLK_OPTB and the average luminance IMG_OPTB are compared with each other on each horizontal line in the optical black region 11, and a gain for equalizing an optical black level of a reference black image with an optical black level of an input image (gain=IMG_OPTB/BLK_OPTB) is obtained on each horizontal line (step S4).

By multiplying each pixel value on the corresponding horizontal line in the effective pixel region 12 of the reference black image by the obtained gain on the horizontal line, a signal level in the effective pixel region 12 of the reference black image is corrected so as to be equal to an optical black level of the input image (step S5).

Then, a pixel value after the correction in the effective pixel region 12 of the reference black image is subtracted from a pixel value of the corresponding pixel in the effective pixel region 12 of the input image to thereby obtain an output image (step S6).

FIG. 3 shows an electric configuration of a video camera.

An output signal of a CCD 10 is converted to a digital signal by an ADC circuit 21. An output signal of the ADC circuit 21 is corrected on a black level thereof by a black level correction circuit 22. An output signal of the black level correction circuit 22 is sent to an image processing circuit 23.

The output signal of the ADC circuit 21 is also sent to a reference black image generating circuit 24. A reference black image generated by the reference black image generating circuit 24 is stored into a frame memory 25. A timing signal is sent to the CCD 10, the reference black image generating circuit 24 and the frame memory 25 from a timing control circuit 26.

In a case where a reference black image is generated when a power supply is turned on, the reference black image generating circuit 24 generates a reference black image using black images in plural frames picked up in a state of light interception. In this case, in order to remove a random noise in an black image, plural frames may be averaged on each particular pixel, or alternatively, plural frames may be filtered with a IIR filter in a chronological direction in the order in which plural frames are picked up.

The black level correction circuit 22 performs black level correction on an input image, using the reference black image held in the frame memory 25.

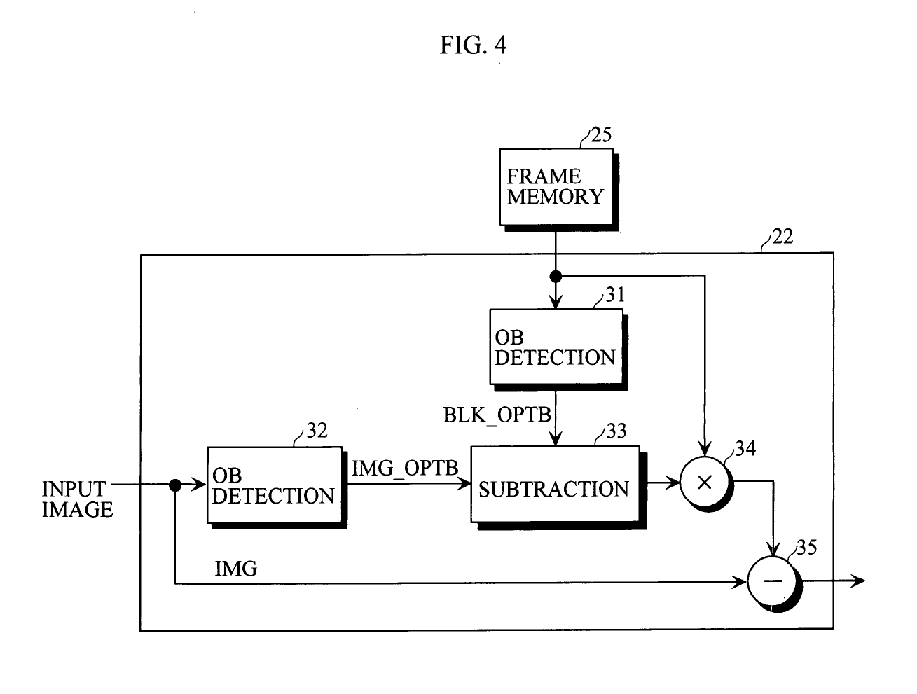

FIG. 4 shows an electric configuration of a black level correction circuit 22.

A first OB detecting circuit 31 calculates an average luminance BLK_OPTB on each horizontal line in the optical black region of the reference black image held in the frame memory 25 to give the average luminance BLK_OPTB to a division circuit 33. On the other hand, a second OB detecting circuit 32 calculates an average luminance IMG_OPTB on each horizontal line in the optical black region of an input image to give the average luminance IMG_OPTB to the division circuit 33.

The subtraction circuit 33 compares the average luminance BLK_OPTB and the average luminance IMG_OPTB on each horizontal line in the optical black region, obtains a gain on each horizontal line (gain=IMG_OPTB/BLK_OPTB), and gives the gain to a multiplication circuit 34.

The multiplication circuit 34 multiplies, each time a gain is given on one horizontal line from the division circuit 33, each pixel value on the corresponding horizontal line in the effective pixel region of the reference black image held in the frame memory 25 by the gain to give a result of the multiplication to a subtraction circuit 35.

The subtraction circuit 35 subtracts the result of multiplication (a pixel value after the correction in the effective pixel region of the reference black image) given from the multiplication circuit 34 from a pixel value of the corresponding pixel in the effective pixel region of an input image to thereby obtain an output image.

According to the example, black level correction can be performed that corresponds to a fluctuation in black level due to a change in exposure time and ambient temperature. In addition, a fixed pattern noise can be removed.

1. A black level correction circuit for a video camera using a solid state image pickup device comprising:
first means generating and holding a reference black image based on an output of the solid state image pickup device in a state of no incident light;
second means calculating an average luminance on each horizontal line in an optical black region of the reference black image;
third means calculating an average luminance on each horizontal line in an optical black region of an input image;
fourth means comparing the average luminance calculated by the second means with the average luminance calculated by the third means on each horizontal line to thereby obtain a gain on the corresponding horizontal line in order to equalize an optical black level of the reference black image with an optical black level of the input image;
fifth means multiplying each of pixel values on each horizontal line in an effective pixel region of the reference black image by the obtained gain on the corresponding horizontal line to thereby correct a signal level in the effective pixel region of the reference black image so as to be equal to an optical black level of the input image; and
sixth means subtracting a pixel value after the correction in the effective pixel region of the reference black image from a pixel value of the corresponding pixel in the effective pixel region of the input image.

2. A black level correction method for a video camera using a solid state image pickup device comprising:
a first step generating and holding a reference black image based on an output of the solid state image pickup device in a state with no incident light;
a second step calculating an average luminance on each horizontal line in an optical black region of the reference black image;
a third step calculating an average luminance on each horizontal line in an optical black region of an input image;
a fourth step comparing the average luminance calculated by the second means with the average luminance calculated by the third means on each horizontal line to thereby obtain a gain on the corresponding horizontal line in order to equalize an optical black level of the reference black image with an optical black level of the input image;
a fifth step multiplying each of pixel values on each horizontal line in an effective pixel region of the reference black image by the obtained gain on the corresponding horizontal line to thereby correct a signal level in the effective pixel region of the reference black image so as to be equal to an optical black level of the input image; and
a sixth step subtracting a pixel value after the correction in the effective pixel region of the reference black image from a pixel value of the corresponding pixel in the effective pixel region of the input image.
